(19) United States
(12) Patent Application Publication
(10) Pub. No.: US 2023/0363452 A1
(43) Pub. Date: Nov. 16, 2023

(54) ATOMIZATION ASSEMBLY CAPABLE OF REALIZING RELIABLE CONNECTION OF ELECTRODES, AND ATOMIZATION DEVICE

(71) Applicant: SHENZHEN HUACHENGDA PRECISION INDUSTRY CO. LTD., Shenzhen (CN)

(72) Inventor: Ping CHEN, Shenzhen (CN)

(73) Assignee: SHENZHEN HUACHENGDA PRECISION INDUSTRY CO. LTD., Shenzhen (CN)

(21) Appl. No.: 18/029,671

(22) PCT Filed: Jul. 23, 2021
(86) PCT No.: PCT/CN2021/108231

§ 371 Date: Mar. 31, 2023

(51) Int. Cl. A24F 40/46; H05B 3/22; A24F 40/10; A24F 40/48; A24F 40/44

(52) U.S. Cl. CPC A24F 40/46; H05B 3/22; A24F 40/10; A24F 40/48; A24F 40/44

(57) ABSTRACT

An atomization assembly includes a heating assembly, a cover, a base and an electrode. The heating assembly includes a heating element and a support. A compartment is disposed on one of the cover and the base and is open towards the other one of the cover and the base. The heating assembly is disposed in the compartment. The heating element is transversely integrated with the top of the support to be supported by the support. The heating assembly is sandwiched between the cover and the base. The heating element includes a main part used for heating and atomizing liquid and an electrical connection part connected to the main part. The electrical connection part is bent from the top of the support to one side of the support. The electrode is in contact with the portion, bent to one side of the support, of the electrical connection part.

### FIELD

The invention relates to the technical field of atomization, in particular to an atomization assembly and an atomization device.

### BACKGROUND

Referring to FIG. 1, the atomization assembly in many atomization devices typically comprises a liquid transfer unit 31 and a heating element 32, wherein liquid is transferred by the liquid transfer unit 31 to the heating element 32 to be heated and atomized, and the heating element 32 is electrically connected to an external battery. The heating element 32 and electrodes 33 of existing atomization assemblies in the art are connected in two manners. First, a lead is welded to the heating element 32, and the heating element 32 is connected to the electrode 33 of the atomization assembly through the lead; by adoption of this kind of connection manner, the contact resistance is low, and the resistance is stable; however, poor welding occurs easily, and the lead is soft and not suitable for automatic assembly and has to be assembled manually, which consumes a large amount of labor. Second, the electrodes 33 are connected with contacts of the heating element 32 of the atomization assembly. The electrodes 33 longitudinally abut against the heating elements 32, and at present, vertical (longitudinal) electrodes 33 are often used in the art and are in direct contact with the contacts at the bottom of the heating element 32; however, due to the fact that the atomization assembly is assembled vertically, the problems of large contact resistance and poor contact may be caused due to poor size accuracy or deformation of upper and lower parts at the joint, which in turn affects the use experience. So, it is of great importance to provide an atomization assembly which is simple, reliable and stable in contact, as well as a connection method for electrodes 33 of the atomization assembly.

### SUMMARY

The technical issue that the invention aims to resolve is to provide, in view of the drawback of the prior art, an atomization assembly in which connection of electrodes is convenient and reliable, and an atomization device.

The technical solution adopted by the present invention to solve the technical issue comprising: providing an atomization assembly which comprises a cover, a base, a heating assembly and an electrode. A compartment, which is matched with the heating assembly, is disposed on one of the cover and the base and is open towards the other one of the cover and the base. The heating assembly is disposed in the compartment, the cover is integrated with the base, the heating assembly is sandwiched between the cover and the base. The heating assembly comprises a support and a heating element, the heating element comprises a main part and an electrical connection part connected to the main part, the main part comprises a heating circuit configured for generating heat to heat and atomize liquid, and the heating element is transversely integrated with a top of the support, such that the heating element is supported by the support. The electrical connection part is bent from the top of the support to one side of the support, or the electrical connection part is bent from the top of the support to one side of the support and is then bent to a bottom of the support, or the electrical connection part is bent from the top of the support to one side of the support and is then engaged into the support.

The electrode comprises a first part, a second part and a third part which are connected to each other, the first part is located on a transverse side of the electrical connection part, and a side face of the first part is at least in contact with the portion, bent to one side of the support, of the electrical connection part to realize electrical connection; the second part is connected to the base; and the third part is exposed out of the base to be in contact with an external circuit to realize electrical connection.

Preferably, the first part and the second part of the electrode are rod-shaped, a radial size of the third part is greater than that of the first part and the second part, and an electrode hole which longitudinally penetrates through the base is formed in the base. After the first part and the second part longitudinally penetrate through the electrode hole, the second part is connected to the base, and the side face of the first part is in contact with the portion, bent to one side of the support, of the electrical connection part.

Preferably, two electrical connection parts are disposed at two ends of the main part respectively. The atomization assembly comprises two said electrodes. Side surfaces of the first parts of the two electrodes are in contact with the two electrical connection parts respectively, and the heating assembly is sandwiched between the two said electrodes.

Preferably, the electrode is elastic plate-shaped, the second part is integrated with the base, and the first part is disposed on one side of the heating assembly, is bent to one side of the support or bent to one side and the bottom of the support, and is in elastic contact with the electrical connection part.

Preferably, the first part is connected to an upper end of the second part, and is bent downwards to form an arched part which arches upwards, and the first part is bent downwards to be in contact with the portion, bent to one side of the support, of the electrical connection part, and is then bent to the bottom of the support to be in contact with the portion, bent to the bottom of the support, of the electrical connection portion.

Preferably, the cover presses a side, opposite to the electrical connection part, of the first part of the electrode, such that the first part elastically presses against the electrical connection part.

Preferably, a protective film is formed on a surface of the electrode and/or on a surface of the electrical connection part of the heating element through electroplating, to prevent a contact position of the electrode and the electrical connection part against oxidization so as to avoid contact resistance being increased.

Preferably, two electrical connection parts are disposed at two ends of the main part respectively. The atomization assembly comprises two said electrodes. The first parts of the two electrodes are in elastic contact with the two electrical connection parts respectively, and the heating assembly is sandwiched between the two said electrodes.

Preferably, an electrode hole is formed in the base, the second part of the electrode is matched with the electrode hole to connect the electrode to the base, and a top of the electrode hole is higher than an inner bottom surface of the base such that liquid in the atomization assembly is prevented from leaking from a gap in the electrode hole.

Preferably, the support comprises a transverse wall and a longitudinal wall, the heating element is integrated with a top of the transverse wall, the longitudinal wall is connected to a bottom edge of the transverse wall, and an air hole longitudinally penetrating through the transverse wall is formed in the transverse wall; the main part of the heating element is transversely integrated with the transverse wall, and the electrical connection part is bent from the transverse wall to a side face of the longitudinal wall.

Preferably, an air vent transversely penetrating through the longitudinal wall is formed in the longitudinal wall and corresponds to the main part of the heating element in position, such that gas generated by heating and atomization of the heating element flows out sequentially through the air hole and the air vent.

Preferably, the support is made of an insulative material, and the support is inseparably or separably integrated with the heating element.

Preferably, the atomization assembly comprises a liquid transfer unit, the compartment is matched with the heating assembly and the liquid transfer unit, and the liquid transfer unit is disposed in the compartment and is in contact with the main part of the heating element, such that liquid is transferred by the liquid transfer unit to the main part to be heated and atomized.

Preferably, the support is made of a material capable of transferring liquid, such that liquid is transferred by the support to the heating element to be atomized and heated.

The technical solution adopted by the present invention to solve the technical issue comprising: providing an atomization device, comprising a shell, and the above-described atomization assembly disposed on the shell, wherein the shell is provided with a liquid delivery structure and a gas outlet structure, and liquid is delivered by the liquid delivery structure to the heating element to be heated and atomized to generate gas, which flows out through the gas outlet structure.

By adopting the technical solution, the invention has at least the following beneficial effects: according to the atomization assembly, the heating element is supported by the support, such that the strength of the heating element is improved; and the electrode can be electrically connected to the electrical connection part of the heating element easily and reliably.

### BRIEF DESCRIPTION OF THE DRAWINGS

The invention will be further described below in conjunction with accompanying drawings and embodiments. In the drawings:

FIG. 1 is an internal structural view of a liquid transfer unit, a heating element and electrodes of a traditional atomization assembly.

FIG. 2 is a perspective view of an atomization assembly according to an embodiment of the invention.

FIG. 3 is a sectional view taken along line A-A in FIG. 2.

FIG. 4 is a partial enlarged view of part P in FIG. 3.

FIG. 5 is a sectional view of a cover in FIG. 3.

FIG. 6 is a perspective view of a heating assembly in FIG. 3 according to an embodiment.

FIG. 7 is an exploded view of the heating assembly in FIG. 6.

FIG. 8 is a perspective view of the heating assembly in FIG. 3 according to another embodiment.

FIG. 9 is an exploded view of the heating assembly in FIG. 8.

FIG. 10 is a perspective view of an atomization assembly according to another embodiment of the invention.

FIG. 11 is a sectional view taken along line B-B in FIG. 10.

FIG. 12 is a sectional view taken along line B-B in FIG. 10 according to another embodiment.

FIG. 13 is a partial enlarged view of part N in FIG. 12.

FIG. 14 is a perspective view of an atomization device according to another implementation of the invention.

FIG. 15 is an exploded view of the atomization device in FIG. 14.

FIG. 16 is a sectional view taken along line C-C in FIG. 14.

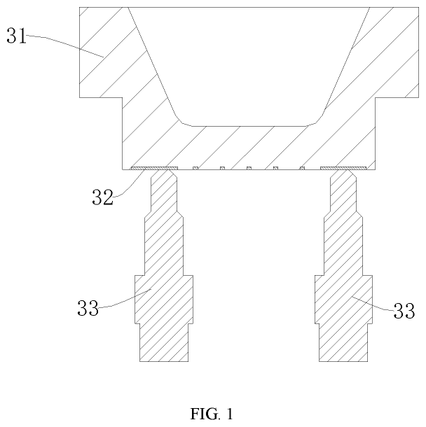

Reference signs: 1, atomization assembly; 11, heating assembly; 111, heating element; 1111, main part; 11111, heating circuit; 1112, electrical connection part; 112, support; 1121, transverse wall; 1122, longitudinal wall; 1123, air hole; 1124, air vent; 12, liquid transfer unit; 13, cover; 131, electrode connection hole; 14, base; 141, electrode hole; 15, compartment; 16, electrode; 161, first part; 162, second part; 163, third part; 164, arched part; 2, shell; 21, liquid storage chamber; 22, gas outlet passage; 31, liquid transfer unit in the background; 32, heating element in the background; 33, electrode in the background.

### DESCRIPTION OF THE EMBODIMENTS

For the sake of a better understanding of the technical features, purposes and effects of the invention, the specific implementations of the invention are described in detail with reference to the accompanying drawings. It should be understood that terms such as “front”, “back”, “upper”, “lower”, “left”, “right”, “longitudinal”, “cross”, “vertical”, “horizontal”, “top”, “bottom”, “inner”, “outer”, “head” and “tail” are used to indicate directional or positional relations, and configuration and operation in specific directions based on the accompanying drawings merely for the purpose of facilitating the description of the technical solution of the invention, and do not indicate that devices or elements referred to must be in a specific direction, so they should not be construed as limitations of the technical solution of the invention. It should be noted that, unless otherwise expressly stated and defined, terms such as “mount”, “link”, “connect”, “fix” and “dispose” should be broadly understood. For example, “connect” may refer to fixed connection, detachable connection or integrated connection; or, direct connection, indirect connection through an intermediate medium, or internal connection or interaction of two elements. When one element is referred to as being “over” or “under” the other element, it may be “directly” or “indirectly” located on the other element, or one or more intermediate elements may exist between these two elements. Terms such as “first”, “second” and “third” in the specification are merely for the purpose of a convenient description of the technical solution of the invention, and should not be construed as indicating or implying relative importance or implicitly indicating the number of technical features referred to. So, when a feature is defined by the terms such as “first”, “second” and “third”, it may explicitly or implicitly indicate the inclusion of one or more said features. Those ordinarily skilled in the art can understand the specific meanings of these terms in the invention as the case may be.

To gain a thorough understanding of the embodiments of the invention, specific details such as system structures and techniques are given in the following description for the purpose of description rather than restriction. It is obvious for those skilled in the art that the invention can also be implemented in other embodiments without these specific details. In other cases, a detailed description of commonly known systems, devices, circuits and methods is omitted to ensure that the invention can be described without being interfered by unnecessary details.

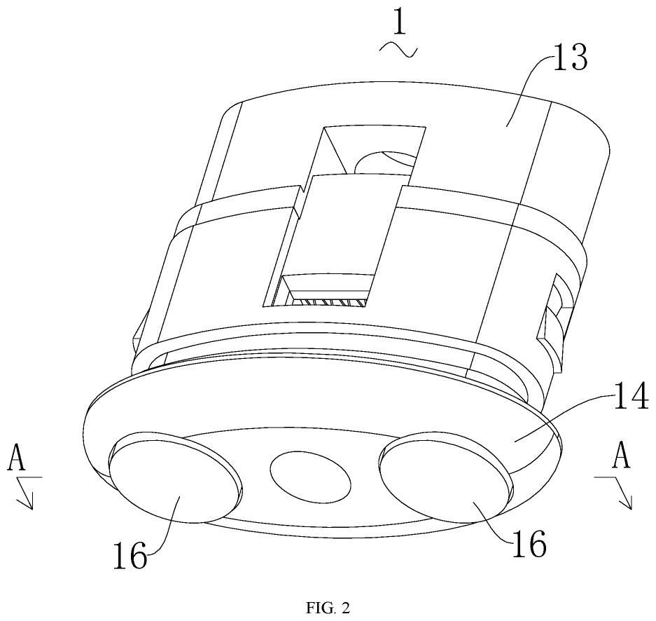

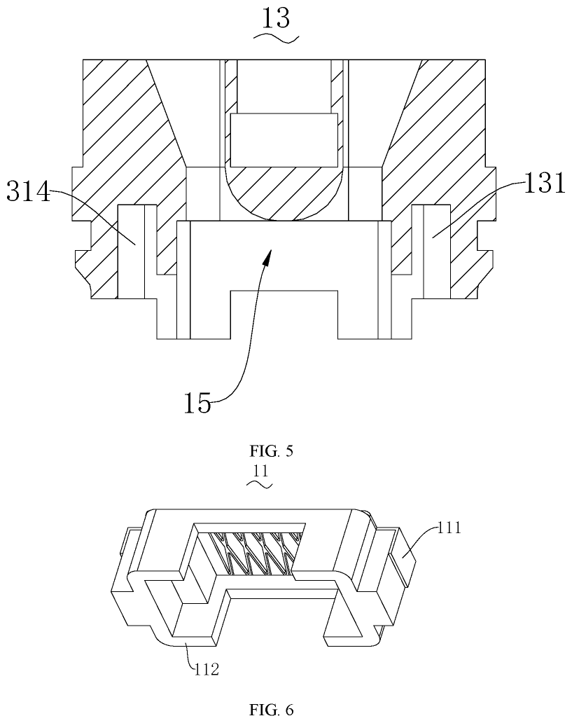

Referring to FIG. 2-FIG. 7, an atomization assembly 1 according to an embodiment of the invention comprises a cover 13, a base 14, a heating assembly 11 and an electrode 16. A compartment 15, which matches the heating assembly 11 in size and shape, is disposed on one of the cover 13 and the base 14 and is open towards the other one of the cover 13 and the base 14, and preferably, the compartment is disposed on the cover. The heating assembly 11 is disposed in the compartment 15, the cover 13 is assembled with the base 14, and heating assembly 11 is sandwiched between the cover 13 and the base 14. The heating assembly 11 comprises a support 112 and a heating element 111. The heating element 111 comprises a main part 1111 and an electrical connection part 1112 connected to the main part 1111. The main part 1111 comprises a heating circuit 11111 used for generating heat to heat and atomize liquid, and the heating element 111 transversely contacts with the top of the support 112, such that the heating element 111 is supported by the support 112. The electrical connection part 1112 is bent from the top of the support 112 to one side of the support 112, or the electrical connection part 112 is bent from the top of the support 112 to one side of the support 112 and is then bent to the bottom of the support 112, or the electrical connection part 1112 is bent from the top of the support 112 to one side of the support 112 and is then engaged in the support 112.

The electrode 16 comprises a first part 161, a second part 162 and a third part 163 which are connected to each other. The first part 161 is located on a transverse side of the electrical connection part 1112, the side face of the first part 161 is at least in contact with the portion, bent to one side of the support 112, of the electrical connection part 1112 to realize electrical connection. The second part 162 is connected to the base. The third part 163 is exposed out of the base 14 to be in contact with an external circuit to realize electrical connection.

According to the atomization assembly 1, the heating element 111 is supported by the support 112, such that the strength of the heating element 111 is improved; and the electrode 16 can be electrically connected to the electrical connection part 1112 of the heating element 111 easily and reliably.

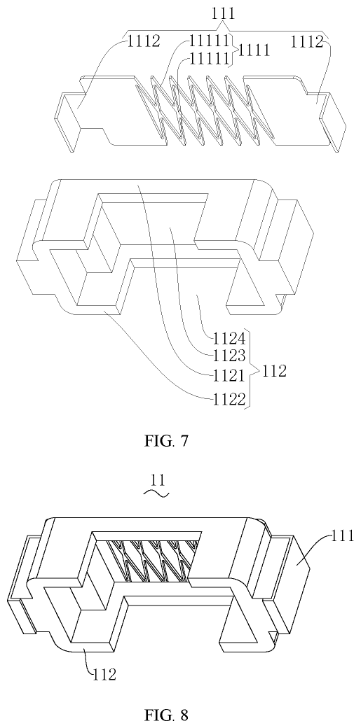

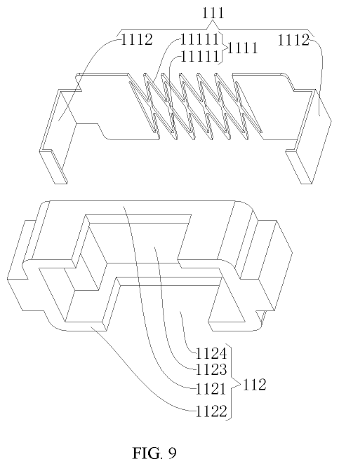

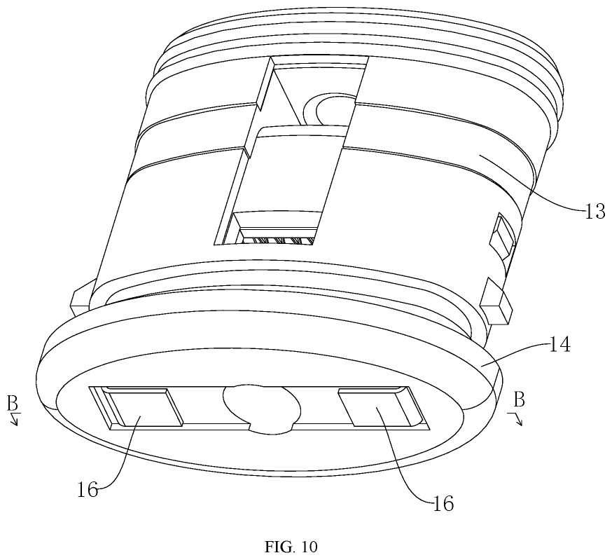

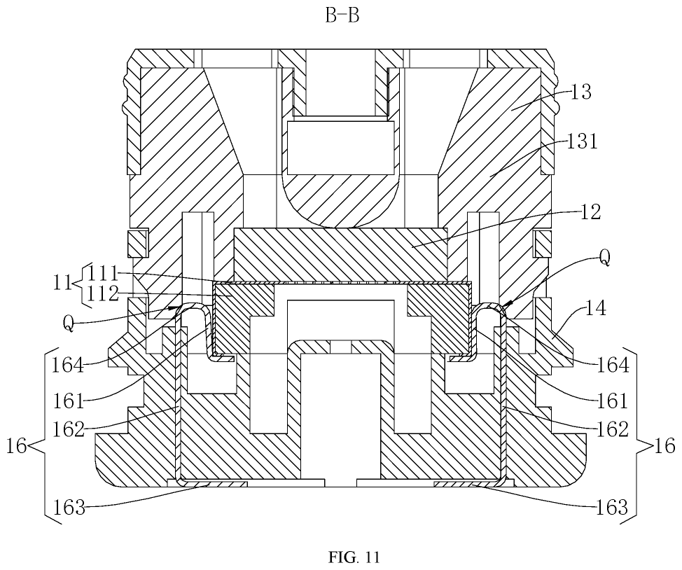

Referring to FIG. 6-FIG. 7, in some embodiments, the electrical connection part 1112 may be bent from the top of the support 112 to one side of the support 112. Referring to FIG. 8-FIG. 9, in some other embodiments, the electrical connection part 1112 may be bent from the top of the support 112 to one side of the support 112 and then bent to the bottom of the support 112, such that the support can be better wrapped, and poor contact caused by deformation due to deviation of the electrical connection part 1112 of the heating element 111 when the electrode is inserted is avoided.

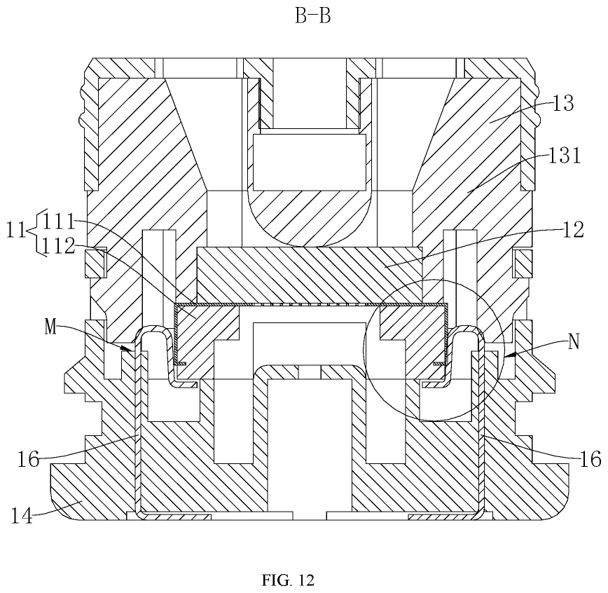

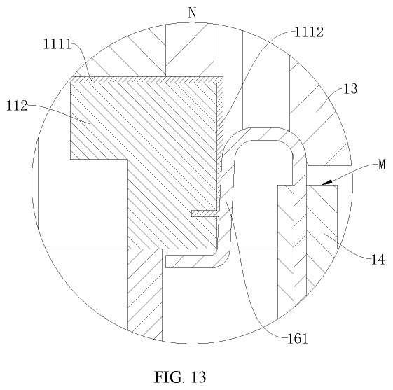

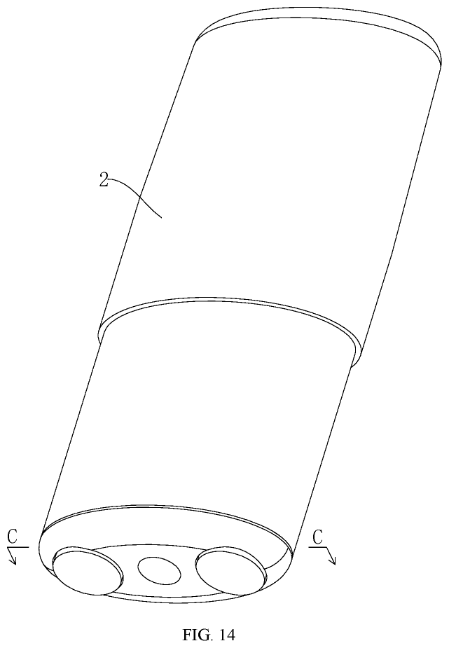

Referring to FIG. 12-FIG. 13, in some embodiments, the electrical connection part 1112 is bent from the top of the support 112 to one side of the support 112 and is then engaged into the support 112. The support 112 is preferably made of plastic, and the heating element 111 and the support 112 may be fixed together through injection molding in a mold, such that the structure is firmer.

Referring to FIG. 12-FIG. 13, in some embodiments, an electrode hole 141 is formed in the base 14, the second part 162 of the electrode 16 is matched with the electrode hole 141 to connect the electrode 16 to the base 14. The top (M in FIG. 12 and FIG. 13) of the electrode hole 141 is higher than the inner bottom surface of the base 14, such that liquid in the atomization assembly 1 is prevented from leaking from a gap of the electrode hole 141.

Referring to FIG. 2-FIG. 5, in some embodiments, the first part 161 and the second part 162 of the electrode 16 are rod-shaped, the radial size of the third part 163 is greater than that of the first part 161 and the second part 162. An electrode hole 141 which longitudinally penetrates through the base 14 is formed in the base 14. After the first part 161 and the second part 162 longitudinally penetrate through the electrode hole 141, the second part 162 is connected to the base 14, and the side face of the first part 161 is in contact with the portion, bent to one side of the support 112, of the electrical connection part 1112.

Two electrical connection parts 1112 are disposed at two ends of the main part 1111 respectively, the atomization assembly 1 comprises two electrodes 16, side walls of the first parts 161 of the two electrodes 16 are in contact with the two electrical connection part 1112 respectively, and the heating assembly 11 is sandwiched between the two electrodes 16.

Preferably, an electrode connection hole 131 which allows the electrode 16 to be inserted therein and corresponds to the electrode hole 141 is longitudinally formed in the cover 13. The electrode connection hole 131 is open towards the electrode hole 141, and the electrode 16 penetrates through the electrode hole 141 and is inserted into the electrode connection hole 131. When the atomization assembly 1 is assembled, the cover 13, the heating assembly 11 and the base 14 are assembled first, and then the electrode 16 is inserted into the electrode hole 141, such that the electrode 16 and the heating element 111 are electrically connected.

The compartment 15 and the electrode connection hole 131 are located on the same side of the cover 13.

The first part 161 of the electrode 16 may be electrically connected to a charger of the atomization assembly 1 to be charged.

In some embodiments, as shown in FIG. 10-FIG. 11, the electrode 16 has a shape of an elastic plate. The second part 162 of the electrode 16 is integrated with the base 14. The first part 161 of the electrode 16 is disposed on one side of the heating assembly 11, is bent to one side of the support 112 or bent to one side and the bottom of the support 112, and is in elastic contact with the electrical connection part 1112. The exposed third part 163 of the electrode 16 may be electrically connected to the charger of the atomization assembly 1 to be charged.

The first part 161 is connected to an upper end of the second part 162 and is bent downwards to form an arched part 164 which arches upwards, and the first part 161 is bent downward to be in contact with the portion, bent to one side of the support 112, of the electrical connection part 1112 and is then bent to the bottom of the support 112 to be in contact with the portion, bent to the bottom of the support 112, of the electrical connection part 1112.

The cover 13 is slightly in interference fit with the first part 161 of the elastic plate-shaped electrode 16, and the cover 13 presses the side, opposite to the electrical connection part 1112, of the electrode 16, such that the first part 161 elastically presses against the electrical connection part 1112. Due to the first part 161 further presses against the electrical connection part 1112, the contact resistance is smaller, and contact is more stable.

The elastic plate-shaped electrode may be engaged with the base through being bent after being inserted into the base or through injection moulding in a mould. The elastic plate-shaped electrode may be formed by stamping, so the electrode is low in cost and elastic, and can be in good contact with the electrical connection part 1112 of the heating element 111, and the requirement for the size of parts is low. To ensure good contact and small contact resistance, the electrode 16 and the electrical connection part 1112 of the heating element 111 may be electroplated such that protective films are formed on the surface of the electrode 16 and/or on the surface of the electrical connection part 1112 of the heating element 111 through electroplating. According to use requirements, the protective film may be formed through electroplating such as gold plating, nickel plating or chromium plating, to prevent the contact position of the electrode 16 and the electrical connection part 1112 from oxidization so as to avoid contact resistance being increased. In FIG. 11, the position Q is the position where the cover 13 presses of the electrical connection part 1112.

Two electrical connection parts 1112 are disposed at two ends of the main part 1111 respectively, the atomization assembly 1 comprises two electrodes 16, the first parts 161 of the two electrodes 16 are in elastic contact with the two electrical connection part 1112 respectively, and the heating assembly 11 is sandwiched between the two electrodes 16.

The support 112 comprises a transverse wall 1121 and a longitudinal wall 1122 surrounding the transverse wall 1121, the heating element 111 is attached to and contacts with the top of the transverse wall 1121, the longitudinal wall 1122 is connected to the bottom edge of the transverse wall 1121, and an air hole 1123 longitudinally penetrating through the transverse wall 1121 is formed in the transverse wall 1121. The main part 1111 of the heating element 111 is attached to and contact with the transverse wall 1121 transversely, and the electrical connection parts 1112 are bent from the transverse wall 1121 to the side faces of the longitudinal wall 1122. An air vent 1124 transversely penetrating through the longitudinal wall 1122 is formed in the longitudinal wall 1122 and the air vent 1124 corresponds to the main part of the heating element in position, such that gas generated by heating and atomization of the heating element 111 flows out sequentially through the air hole 1123 and the air vent 1124.

The support 112 is made of an insulative material, and is inseparably or separably integrated with the heating element 111.

The transverse size of a liquid transfer unit 12 matches the transverse size of the compartment 15. The support 112 supports the bottom of the heating element 111; the transverse size of the heating element 111 matches the transverse size of the support 112, and preferably, the transverse size of the heating element 111 is equal to the transverse size of the support 112.

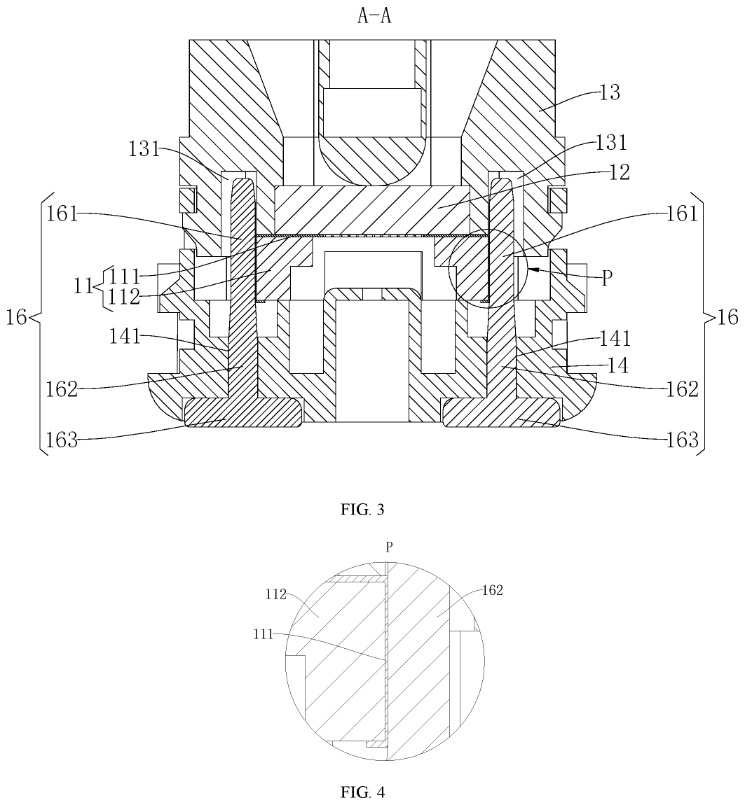

In some embodiments, referring to FIG. 3 and FIG. 11, the atomization assembly 1 comprises a liquid transfer unit 12, the compartment 15 is matched with the heating assembly 11 and the liquid transfer unit 12, and the liquid transfer unit 12 is disposed in the compartment 15 and is in contact with the main part 1111 of the heating element 111, such that liquid is transferred by the liquid transfer unit 12 to the main part 1111 to be heated and atomized. In some other embodiments, the support 112 is made of a material capable of transferring liquid, such as ceramic internally provided with many pores, the liquid transfer unit is omitted, and liquid is transferred by the support 112 to the heating element 111 to be atomized and heated.

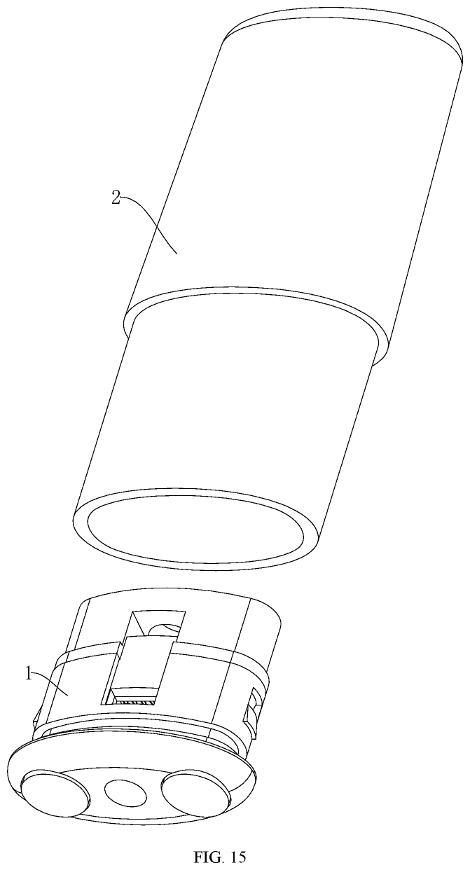

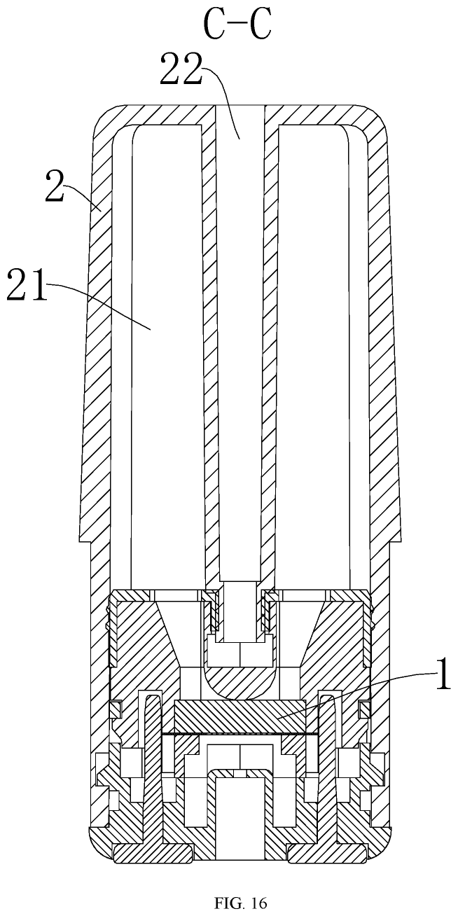

Referring to FIG. 14-FIG. 16, an atomization device according to an embodiment of the present invention comprises a shell 2 and the above-described atomization assembly 1 disposed in the shell 2. The shell is provided with a liquid delivery structure and a gas outlet structure. The liquid delivery structure is communicated with the liquid transfer unit 12, such that liquid flows to the liquid transfer unit 12 through the liquid delivery structure, and is then transferred by the liquid transfer unit 12 to the heating element 111 to be heated and atomized to generate gas, which flows out through the gas outlet structure. Preferably, the liquid delivery structure comprises a liquid storage chamber 21, and the gas outlet structure comprises a gas outlet passage 22.

In summary, in the atomization assembly 1 and the atomization device, the electrodes 16 and the heating element 111 are electrically connected easily and reliably. A method of not welding leads may be adopted. The electrodes 16 are disposed on two sides of the heating element 111, and the side faces of the electrodes 16 are in contact with the electrical connection parts 1112 of the heating element 111.

The invention has the following advantages:
1. Welding leads is not needed, so labor is saved, subsequent automatic assembly is facilitated, and the situation where the automation assembly 1 does not work due to an open circuit caused by poor welding is avoided.
2. The contact portion of the electrode 16 in contact with the heating element 111 is located on the side face of the heating assembly 11, and is not affected by the size of upper and lower assembly structures, so poor contact caused by poor accuracy is avoided.
3. Generally, the number of the electrodes 16 is two, the two electrodes 16 are disposed on two sides of the heating assembly respectively, the contact portions of the electrodes 16 in contact with the heating element 111 are located on side faces of the electrical connection parts 1112 of the heating element 111, and the heating assembly is clamped between the side faces of the two electrodes 16, so good contact is realized, and the heating assembly 11 is fixed.

The above embodiments are merely preferred ones of the invention, and are not used to limit the invention. Those skilled in the art can make various modifications, combinations and changes to the invention. Any amendments, equivalent substitutions and improvements made based on the spirit and principle of the invention should fall within the scope of the claims.

1. An atomization assembly (1), comprising a cover (13), a base (14), a heating assembly (11) and an electrode (16), wherein a compartment (15), which is matched with the heating assembly (11), is disposed on one of the cover (13) and the base (14) and is open towards the other one of the cover (13) and the base (14), the heating assembly (11) is disposed in the compartment (15), the cover (13) is integrated with the base (14), the heating assembly (11) is sandwiched between the cover (13) and the base (14); the heating assembly (11) comprises a support (112) and a heating element (111), the heating element (111) comprises a main part (1111) and an electrical connection part (1112) connected to the main part (1111), the main part (1111) comprises a heating circuit (11111) configured for generating heat to heat and atomize liquid, and the heating element (111) is transversely integrated with a top of the support (112), such that the heating element (111) is supported by the support (112); the electrical connection part (1112) is bent from the top of the support (112) to one side of the support (112), or the electrical connection part (1112) is bent from the top of the support (112) to one side of the support (112) and is then bent to a bottom of the support (112), or the electrical connection part (1112) is bent from the top of the support (112) to one side of the support (112) and is then engaged into the support (112);
the electrode (16) comprises a first part (161), a second part (162) and a third part (163) which are connected to each other, the first part (161) is located on a transverse side of the electrical connection part (1112), and a side face of the first part (161) is at least in contact with the portion, bent to one side of the support (112), of the electrical connection part (1112) to realize electrical connection; the second part (162) is connected to the base (14); and the third part (163) is exposed out of the base (14) to be in contact with an external circuit to realize electrical connection.

2. The atomization assembly (1) according to claim 1, wherein the first part (161) and the second part (162) of the electrode (16) are rod-shaped, a radial size of the third part (163) is greater than that of the first part (161) and the second part (162), and an electrode hole (141) which longitudinally penetrates through the base (14) is formed in the base (14), after the first part (161) and the second part (162) longitudinally penetrate through the electrode hole (141), the second part (162) is connected to the base (14), and the side face of the first part (161) is in contact with the portion, bent to one side of the support (112), of the electrical connection part (1112).

3. The atomization assembly (1) according to claim 2, wherein two said electrical connection parts (1112) are disposed at two ends of the main part (1111) respectively, the atomization assembly (1) comprises two said electrodes (16), side surfaces of the first parts (161) of the two electrodes (16) are in contact with the two electrical connection parts (1112) respectively, and the heating assembly (11) is sandwiched between the two said electrodes (16).

4. The atomization assembly (1) according to claim 1, wherein the electrode (16) is elastic plate-shaped, the second part (162) is integrated with the base (14), and the first part (161) is disposed on one side of the heating assembly (11), is bent to one side of the support (112) or bent to one side and the bottom of the support (112), and is in elastic contact with the electrical connection part (1112).

5. The atomization assembly (1) according to claim 4, wherein the first part (161) is connected to an upper end of the second part (162), and is bent downwards to form an arched part (164) which arches upwards, and the first part (161) is bent downwards to be in contact with the portion, bent to one side of the support (112), of the electrical connection part (1112), and is then bent to the bottom of the support (112) to be in contact with the portion, bent to the bottom of the support (112), of the electrical connection portion (1112).

6. The atomization assembly (1) according to claim 4, wherein the cover (13) presses a side, opposite to the electrical connection part (1112), of the first part (161) of the electrode (16), such that the first part (161) elastically presses against the electrical connection part (1112).

7. The atomization assembly (1) according to claim 4, wherein a protective film is formed on a surface of the electrode (16) and/or on a surface of the electrical connection part (1112) of the heating element (111) through electroplating, to prevent a contact position of the electrode (16) and the electrical connection part (1112) against oxidization, such that contact resistance is prevented from being increased.

8. The atomization assembly (1) according to claim 4, wherein two said electrical connection parts (1112) are disposed at two ends of the main part (1111) respectively, the atomization assembly (1) comprises two said electrodes (16), the first parts (161) of the two electrodes (16) are in contact with the two electrical connection parts (1112) respectively, and the heating assembly (11) is sandwiched between the two said electrodes (16).

9. The atomization assembly (1) according to claim 4, wherein an electrode hole (141) is formed in the base (14), the second part (162) of the electrode (16) is matched with the electrode hole (141) to connect the electrode (16) to the base (14), and a top of the electrode hole (141) is higher than an inner bottom surface of the base (14), such that liquid in the atomization assembly (1) is prevented from leaking from a gap in the electrode hole (141).

10. The atomization assembly (1) according to claim 1, wherein the support (112) comprises a transverse wall (1121) and a longitudinal wall (1122), the heating element (111) is integrated with a top of the transverse wall (1121), the longitudinal wall (1122) is connected to a bottom edge of the transverse wall (1121), and an air hole (1123) longitudinally penetrating through the transverse wall (1121) is formed in the transverse wall (1121); the main part (1111) of the heating element (111) is transversely integrated with the transverse wall (1121), and the electrical connection part (1112) is bent from the transverse wall (1121) to a side face of the longitudinal wall (1122).

11. The atomization assembly (1) according to claim 10, wherein an air vent (1124) transversely penetrating through the longitudinal wall (1122) is formed in the longitudinal wall (1122) and corresponds to the main part (1111) of the heating element (111) in position, such that gas generated by heating and atomization of the heating element (111) flows out sequentially through the air hole (1123) and the air vent (1124).

12. The atomization assembly (1) according to claim 1, wherein the support (112) is made of an insulative material, and the support (112) is inseparably or separably integrated with the heating element (111).

13. The atomization assembly (1) according to claim 1, wherein the atomization assembly (1) comprises a liquid transfer unit (12), the compartment (15) is matched with the heating assembly (11) and the liquid transfer unit (12), and the liquid transfer unit (12) is disposed in the compartment (15) and is in contact with the main part (1111) of the heating element (111), such that liquid is transferred by the liquid transfer unit (12) to the main part (1111) to be heated and atomized.

14. The atomization assembly (1) according to claim 1, wherein the support (112) is made of a material capable of transferring liquid, such that liquid is transferred by the support (112) to the heating element (111) to be atomized and heated.

15. An atomization device, comprising a shell (2), and the atomization assembly (1) according to claim 1 disposed on the shell (2), wherein the shell (2) is provided with a liquid delivery structure and a gas outlet structure, and liquid is delivered by the liquid delivery structure to the heating element (111) to be heated and atomized to generate gas, which flows out through the gas outlet structure.

16. The atomization assembly (1) according to claim 5, wherein the cover (13) presses a side, opposite to the electrical connection part (1112), of the first part (161) of the electrode (16), such that the first part (161) elastically presses against the electrical connection part (1112).

17. The atomization assembly (1) according to claim 5, wherein a protective film is formed on a surface of the electrode (16) and/or on a surface of the electrical connection part (1112) of the heating element (111) through electroplating, to prevent a contact position of the electrode (16) and the electrical connection part (1112) against oxidization, such that contact resistance is prevented from being increased.

18. The atomization assembly (1) according to claim 5, wherein two said electrical connection parts (1112) are disposed at two ends of the main part (1111) respectively, the atomization assembly (1) comprises two said electrodes (16), the first parts (161) of the two electrodes (16) are in elastic contact with the two electrical connection parts (1112) respectively, and the heating assembly (11) is sandwiched between the two said electrodes (16).

19. The atomization assembly (1) according to claim 5, wherein an electrode hole (141) is formed in the base (14), the second part (162) of the electrode (16) is matched with the electrode hole (141) to connect the electrode (16) to the base (14), and a top of the electrode hole (141) is higher than an inner bottom surface of the base (14), such that liquid in the atomization assembly (1) is prevented from leaking from a gap in the electrode hole (141).

20. An atomization device, comprising a shell (2), and the atomization assembly (1) according to claim 2 disposed on the shell (2), wherein the shell (2) is provided with a liquid delivery structure and a gas outlet structure, and liquid is delivered by the liquid delivery structure to the heating element (111) to be heated and atomized to generate gas, which flows out through the gas outlet structure.
